(19) United States
(12) Patent Application Publication
(10) Pub. No.: US 2021/0160234 A1
(43) Pub. Date: May 27, 2021

(54) CENTRALIZED BIOMETRIC USER PROFILE SETUP IN INTERNET GATEWAY DEVICE FOR NETWORK ACCESS

(71) Applicant: MONIKA AGARWAL, IRVING, TX (US)

(72) Inventor: MONIKA AGARWAL, IRVING, TX (US)

(73) Assignee: OURVISION TECHNOLOGIES LLC, IRVING, TX (US)

(21) Appl. No.: 16/698,847

(22) Filed: Nov. 27, 2019

(51) Int. Cl. H04L 29/06

(52) U.S. Cl. CPC H04L 63/0861; H04L 63/102

(57) ABSTRACT

A method, an apparatus, a communication device and a computer program product for biometric identification of users who wants to access the network, are provided. The apparatus may be an Internet Gateway Device, Router, Customer Premise Equipment or a Managed Gateway device. The apparatus may detect biometric information using a computer software program and sensors. The apparatus may then use computer program to compare the detected biometric information of a user with stored biometric information associated with a stored user's biometric profile of a plurality of user profiles. The apparatus may then determine whether to provide the web access with full or limited privileges based on comparison of received provided biometric information with stored biometric information or even deny the access request, received from a communication device.

### BACKGROUND

### Field of the Invention

The present disclosure relates to the internet access of user devices and more particularly, access, based on the centralized biometric user profiles, stored in the IGD.

### Background of the Invention

In today's world, all children have access to all kind of electronic and communication devices which interact on the World Wide Web, also known as internet and they do almost the same things that many other adults do. The use of such devices and applications poses a number of problems. One such problem is children usually buy contents which include renting and purchase of digital content, buying of products on websites. Another major problem is their access to adult and harmful content over the internet. If parents allow children to access the internet, it becomes extremely difficult for parents to monitor the children for what they are accessing and how much. An additional problem is that if a parent allows children to use a computer, tablet, laptop or a mobile to access websites, they cannot discern what activities those children participated in after the fact, or approve those activities while they were occurring.

As stated above, current communication, do not have mechanism that allows parents to approve or set the restriction for the usage of internet and the actions that children perform in web. Moreover we do not have mechanism that report back the activity of children done on the web, back to parents or guardians.

Current monitoring or restriction services are complex and require installation of additional services like YouTube Kid, which is an app version especially for children, but still children can access full version of YouTube and websites on any of the device. Additionally there are some provisions to block the devices from using the internet and set the time limit on them, but they are cumbersome and still they are not very specific to this problem and doesn't solve the restricted usage and permission problem.

Another good description of use case is a places like schools, colleges, offices, airport, train stations or any other place which has the internet access available but has to maintain the different network names and SSID for different kind of users with different privileges. Instead we suggest to have centralized biometric user profile setup in IGD and IGD to allow the same content access privileges to a user, irrespective of the device being used.

### BRIEF SUMMARY OF THE INVENTION

Same user, any device, same permission. Embodiments of the present disclosure are directed towards the creation of Centralized biometric user profile of the users based on their age or permissions desired. Then adding biometric information of the users to these biometric profiles and putting the access level permissions and restrictions for these profiles. Further embodiment allows parents or admins to set filters on the websites or URL, to which a biometric user profile may or may not be allowed. Such an embodiment will allow a set and subset of keywords which can be put in the restriction list of these biometric user profiles.

One embodiment of the disclosure is directed toward a mandatory biometric profile information requested by the Internet Gateway Device, referred to as IGD or CPE in exchange of a connection request, failing to which the connection will be denied.

One such embodiment also states that if the biometric profile information is not provided during connection request process, before access of internet, the device will get access to a Guest profile, which will have limited and minimum access to internet at lowest possible speed.

Other features and aspects of the invention will become apparent from the following detailed description, taken in conjunction with the accompanying drawings, which illustrate, by way of example, the features in accordance with embodiments of the invention. The summary is not intended to limit the scope of the disclosure, which is defined solely by the claims attached hereto.

### BRIEF DESCRIPTION OF THE DRAWINGS

The present disclosure, in accordance with one or more various embodiments, is described in detail with reference to following figures. The drawings are provided for the purpose of illustration only and merely depict typical or example embodiments of the invention. These drawings are provided to facilitate the reader's understanding of the invention and shall not be considered limiting of the breadth, scope, or applicability of the invention.

FIG. 1 is a use case diagram depicting Biometric User Profiles are being created in the Internet Gateway Device or Managed CPE by using the Biometric Information from the Users.

FIG. 2 is a block diagram depicting all the users with their biometric details in the premises are being added to biometric profiles created in the IGD.

FIG. 3 is a flow chart depicting the Biometric User Profiles being created, permission being set for each user and authentication and verification being done for each incoming request.

FIG. 4 is a sequence diagram depicting when a device tries to access web, the steps that it has to follow.

FIG. 5 is a sequence diagram which tries to depict the users as a family members based on their age and permissions set and the access level set to them in the IGD.

FIG. 6 is a sequence diagram depicting when different users of home, use the Connected Home device to access the internet.

FIG. 7 is a sequence diagram depicting the behavior of Internet Gateway Device when COHO devices try to access the web.

FIG. 8 is a sequence diagram explaining the process of Centralized biometric user profile setup being used in schools.

FIG. 9 is a sequence interaction diagram explaining when a user with multiple devices, accesses internet, he is identified by IGD using biometric credentials and same access level is allowed throughout all the devices.

These figures are not intended to be exhaustive or to limit the invention to the precise form disclosed.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However it will be apparent to those skilled in the art that these concepts may be practiced without these specific details. In some instances, well known components and structures are shown in block diagram form, in order to avoid obscuring such concepts.

Several aspects of Centralized Biometric Profile setup with Internet Gateway Device will now be presented with reference to various apparatus and methods. These apparatus and methods will be described in the following detailed description and illustrated in the accompanying drawings by various blocks, modules, components, steps, processes, algorithms and collectively referred to as modules. These modules may be implemented using electronic hardware, software program or any combination thereof. Whether these modules are implemented as hardware or software depends upon the particular application and design constraints imposed on the overall system.

Internet Gateway Device “IGD” or CPE may be used to add biometric details of each member or users of the Local Area Network, independent of the way they will be connected in the LAN. Once the Biometric Users Profiles are added, their details can be added like Name and Age. Based on their age and other requirements, permissions can be set to these biometric profiles. Permission can vary from allowing a user to browse a website, buy, and rent, share the data including movies, online over the internet. Centralized Biometric User Profiles at IGD will also allow the third party apps like YouTube, Hulu, and Netflix and may others but not limited to several Games, to query IGD about the Permissions and restrictions associated to a biometric user profile using a device. Another embodiment also allows a Connected Home “COHO” device to work differently for different users. For example, a streaming device can always check with the IGD about the permission associated with the current user and allow the content to be accessed accordingly. A shared device like a COHO or a Smart Home device may simply place the request to access the web along with the identified user and then IGD may check the permissions stored in its database for the received user and then allow or restrict the content for that particular user. One approach also suggests that after a device places a connection request, it has to share the user information and the final actions and permissions will be decided by the IGD based on proper validation of biometric user profiles.

In some cases Biometric User Profiles can be implemented based on permissions allowed. In some embodiments Biometric User Profiles can be implemented to decide the permissions for each user and plurality of the devices. In further embodiments restrictions can be implemented on the contents that a user may be trying to access using a listed device. In some instances, devices and apps can check with the IGD about the permissions a user has, instead of maintaining their own mechanisms of creating and logging into user profiles.

As described above, Internet Gateway Router “IGD” or Customer Premises Equipment “CPE” may have one or More Biometric user profiles, each having a different set of permissions to access the information, data and contents over the internet. When the user who is a member of the family tries to access internet using this IGD, IGD should first decide the permissions attached to this user. IGD may also send a periodic information to the admin, about the usage of the internet on these devices by all users and any violations if attempted. If any member/user tries to access the content which is not allowed, a message should be displayed to the user, asking him if he wants to take an approval from admin, if selected yes, an app notification should be sent to the admin, which he can approve biometrically from his mobile.

In the real world usage, while watching Video On Demand “VOD” using apps like YouTube, Netflix, Hulu, etc. . . . , no local or app level security will be required, instead these app will query IGD locally if it approves the content. While purchasing contents, apps will check the permission level directly from IGD. Most of the benefit can be leveraged by using the Biometric profiles set at the IGD or CPE as, same level of permission throughout the home, on all the devices and apps, for the same user. As described above, user devices may have one or more user profiles, each having a different set of permissions to access the information stored on the user device and to perform functions. When sharing a user device, a user may want to avoid a potentially lengthy process of logout and login. A more faster and convenient way for the same is needed, in which devices may switch the profiles based on the policy that is set for that device in the IGD. In one aspect, a user device can have multiple biometric sensors. In another aspect a user device may have no biometric sensor and they can query permissions from IGD based on user names or login id. The biometric sensors may detect the user, who is using the device with stored biometric information associated with the stored biometric user profile in a database and to decide whether to allow the user full access or not. Examples of a user device, but not limited to, are, a phone, a cellular phone, a smart phone, a laptop, a personal Digital Assistant (PDA), a multimedia device, a video device, a digital Audio player, camera, a game console, tablet, Voice enabled smart devices like Alexa and Google home, Google Nest or any other similar operating device. Several exemplary environments in which the Centralized Biometric User Profile Setup in the Internet Gateway Device may be employed will now be described.

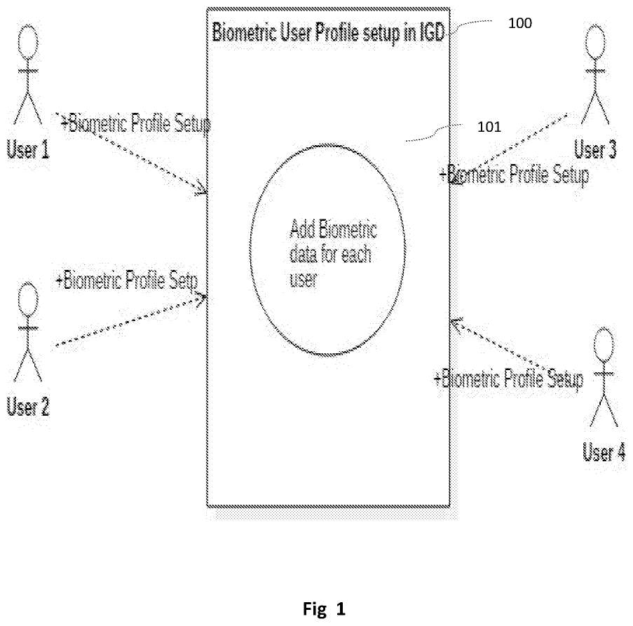

FIG. 1 is an illustration of a Use Case diagram, in which Users 1, User 2, User 3 and User 4 have their biometric profile setup in the Internet Gateway Device 100. As shown in FIG. 1, 101 is the collection of all the biometric information for all the users which will be using this Internet Gateway Device “IGD” or sometimes referred to as Customer Premises Equipment “CPE”. An administrator of the IGD or CPE can add users, create their biometric profile based on their name and age, and add biometric information of all the users.

In one configuration, biometric sensors may be connected to the IGD and users User1, User2, User3 and User 4 be allowed to enter their biometric information and get stored in the database of the IGD 101 holding the biometric information for each user. In another configuration, using a mobile app of IGD or web interface, profiles may be transferred or downloaded to IGD 100 from another database or applications and stored against each user and their profiles created in database of IGD 101.

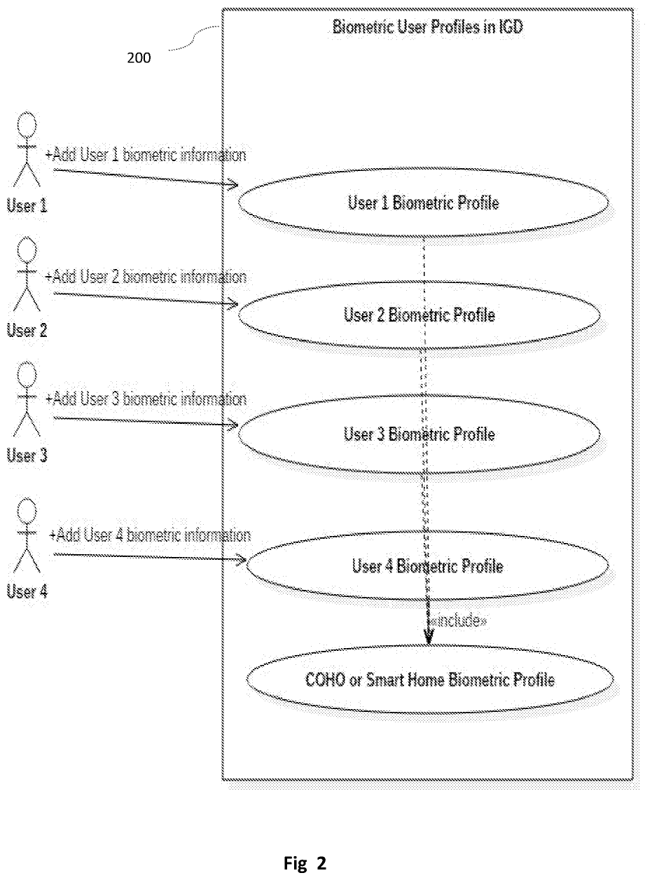

FIG. 2 is a depiction of Block diagram depicting how Users (User 1, User 2, User 3, and User 4) are added to their Biometric User Profiles and COHO which is created in the Internet Gateway Device 200 or sometimes referred to as Consumer Premise Equipment. In the referred diagram, the admin, after creating the biometric user profile, adds the biometric information of the users to their profiles. This biometric information can be fingerprint information, voice samples, and electrocardiogram information, tissue capacitance measurements, touch-based behavioral movements (e.g., Silent Sense), face recognition, retina scan, and any other biometric information. This biometric information may be collected using biometric sensors or may be transferred from other devices or databases. Now there is a special profile here for Smart Home devices or COHO devices. These devices may be used interchangeably by different members or users which exists in the same LAN. This COHO profile can access all the user profiles and can have special set of instructions or permissions associated to operate and issue commands. There is a use case, for example, a 7 year old member of a family may not be allowed to unlock the front door of the house using smart home devices. This basically means, different actions performed by the same user, in different scenarios on different devices but access rights controlled by IGD based on biometric profile information and rights associated to that account. A COHO device in real life has communication with almost all the devices in the house, used by all the users. Same way its profile is created in a little different way on the IGD in this figure, adding different biometric user profiles with different set of permissions. For example, if a user, who is a 7 year old child has no permission to play certain videos on YouTube app on a smart TV or mobile phone, will not be allowed to use a COHO device, which may be a video streaming device like Amazon Cube, Fire TV Stick, Roku or any other streaming and broadcast app device, to play that video. This clearly demonstrates the use case and requirement of a single user, same restriction, all device concept.

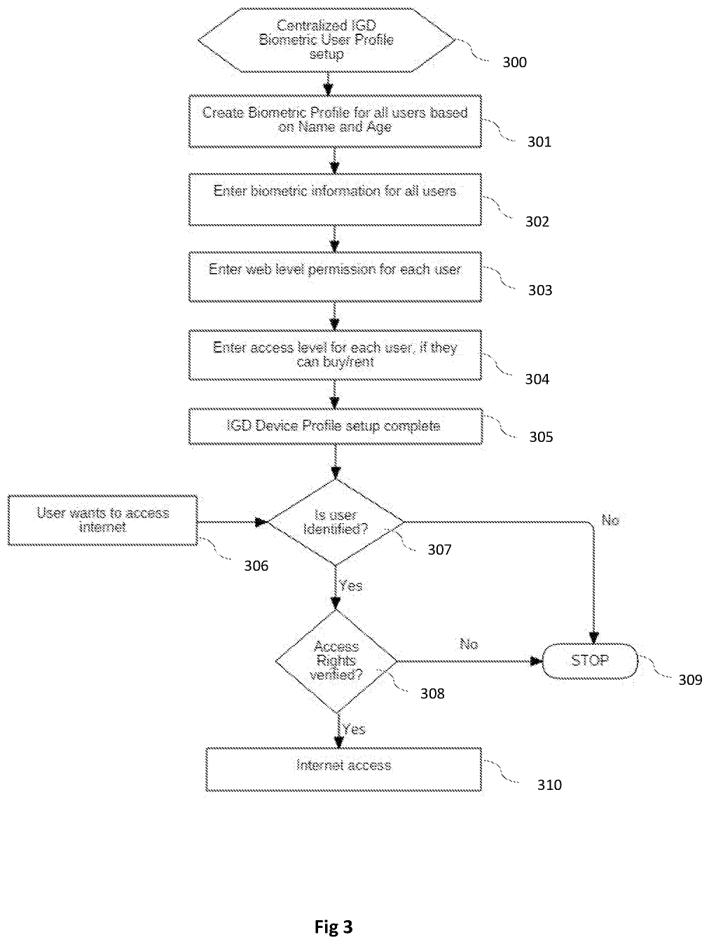

FIG. 3 depicts a flowchart, whose purpose is to present the entire flow from creating the centralized biometric user profile and till handling the traffic coming from different devices operated by different users across the LAN. In step 300, admin prepared the IGD for Biometric User Profile setup. In step 301, admin creates the Biometric User Profiles for all the users available who will be using the network, based on their name and date of birth. In Step 302, admin adds the biometric information for all the users. This information can either be added to IGD using some additional gadgets, tools, devices and apps having sensors or can be transferred or downloaded from other databases or profiles by using any of the best known methods. In Step 303, admin adds permission for each user based on several factors like age, gender, requirements related to education. In step 304, admin adds extra permissions and restrictions to these profiles stating if the user can buy/rent any digital content or do any shopping over the web. In step 305, Centralized Biometric User Profile setup is complete and can now handle the users across the LAN. In step 306, when a user wants to access the internet, his credentials are subjected to verification at step 307 using the centralized biometric user profile setup.

If the user is identified, in step 308, he undergoes additional check of verifying the user rights. If the rights are set by the admin to access the internet, in step 310, user gets the access to internet. In contrast, if the user is not identified in step 307, he is not allowed access as shown in step 309. Also, if the user is identified but has no permission to use the requested service or website access as shown in step 308, he is denied the service as shown in step 309. Another embodiment states that these types of users who doesn't match with biometric user profile in IGD, can be treated as guest users with limited access.

This proves the concept of permissions being set for the users based on their biometric credentials which are stored in the IGD and not based on the devices, thereby providing single user, any device, same permissions.

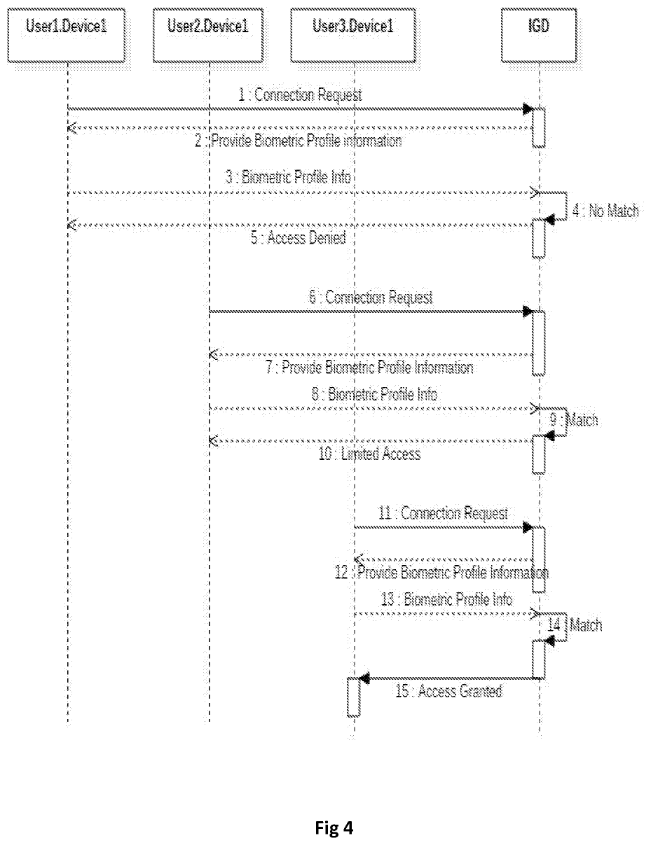

FIG. 4 demonstrates a sequence diagram where different users with different devices and the plurality of combinations contact the IGD for accessing the internet and IGD, after verifying the biometric data of each user, sets the permission level for each incoming request or for a particular session, based on how this is implemented. In the FIG. 4, Step 1, when the User 1, uses Device 1 to access make a connection request, IGD requests for Biometric User information as shown in Step 2. After receiving the biometric information of the user, from the device or the app installed on that device as shown in Step 3, IGD matches this received biometric profile information with stored biometric profile information as shown in step 4 and finds the restrictions to be set as FULL and hence denies the access completely as shown in Step 5. In another session, in step 6, when the User 2 using Device 1 tries to access the internet, IGD requests for the Biometric profile information in step 7, and when in step 8, Device 1 provides that information to IGD, it verifies the received biometric data with the stored biometric data in step 9 and after a match, it allows limited or partial access to that session being used by User 2 in step 10. In the same FIG. 4, when User 3 uses the same Device 1 at step 11, it makes a connection with IGD and after the connection request, IGD requests for the biometric user information in step 12 from Device 1. After receiving this information in step 13, in step 14, IGD makes a comparison of the biometric profile information received with the biometric profile information stored. Since this information matches and the access is set to FULL, the user 3 gets the full privileges with no restrictions set as shown in step 15. This FIG. 4 depicts the idea of Multiple Users, single device, same restriction level for every user throughout LAN irrespective of the device being used.

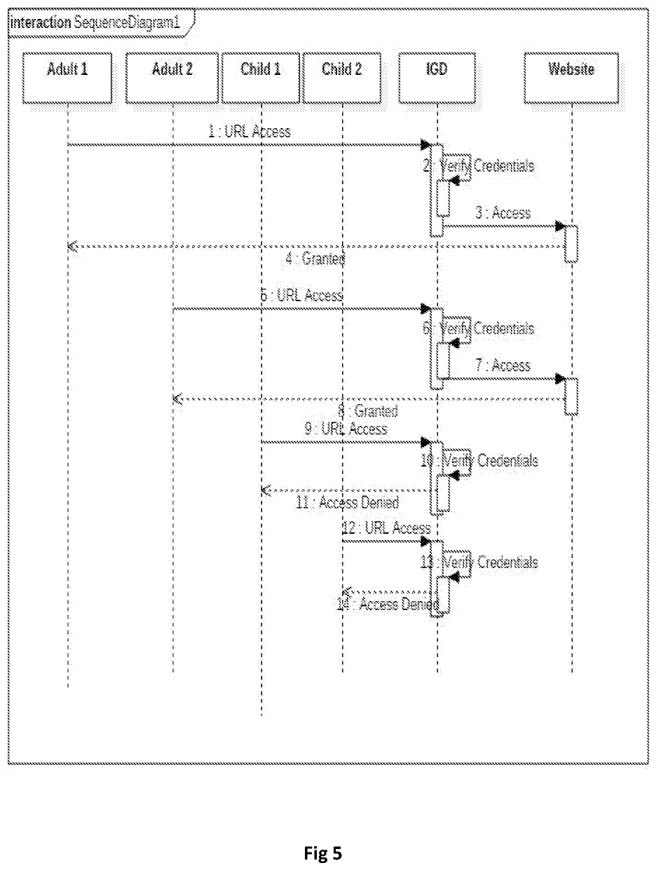

FIG. 5 is a high level sequence diagram which depicts sequence of which can be followed in a home or a school or any institution including offices, where in different users are set to use the internet on different devices with different permissions, set throughout, irrespective of the device being used. In this FIG, Adult 1, tries to access a website at step 1, request of which passes through the IGD. At step 2, on receiving the request IGD verifies the received Biometric Profile information of the Adult 1 with the information stored in the IGD database. Since the information match was a success with access level set to FULL, at step 3, Adult 1, was allowed to visit the website and the user, Adult 1 was informed at step 4 for access being granted. Adult 2, tries to access a website using step 5, request of which passes through the IGD. At step 6, on receiving the request, IGD verifies the received Biometric Profile information of the user Adult 2 with the information stored in the IGD database. Since the information match was a success with access level set to FULL, at step 7, Adult 2, was allowed to visit the website and was informed of the access request using step 8. When Child 1, tries to access a website at step 9, request of which passes through the IGD. At step 10, on receiving the request, IGD verifies the received Biometric Profile information of the Kid 1 with the information stored in the IGD database. Since the information match was a failure with access level set to NULL, at step 11, Child 1, was informed of the decision and the access was denied. When Kid 2, tries to access a website at step 12, request of which passes through the IGD. At step 13, on receiving the request IGD verifies the received Biometric Profile information of the user, who is Kid 2, with the information stored in the IGD database. Since the information match was a failure with access level set to NULL, at step 14, Kid 2, was denied to visit the website. This is a very clear example of the concept, Centralized Biometric User Profile Setup in IGD.

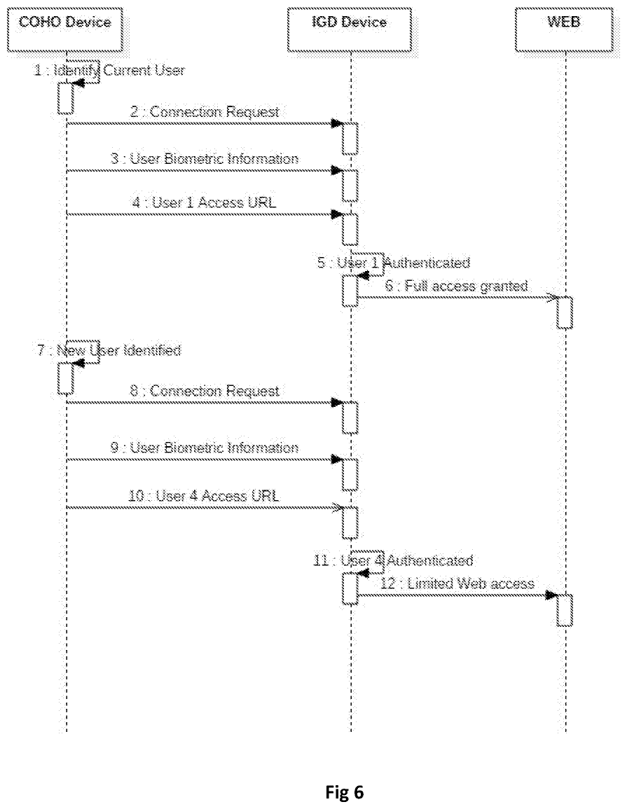

FIG. 6 is a sequence diagram depicting the use of Centralized Biometric User Profile in the home using a Connected Home device such as voice enabled devices like Alexa or Fire TV which can stream a video on multiples apps installed on the device. In this example, when the COHO device makes a connection request with IGD as shown in step 2, first it has to identify the current user as shown in step 1. Now after connection request is made, User details are shared with IGD in step 3, which will help IGD to do an authentication of the user and compare the access rights. Now in step 4, a web request is placed by the user, which is shown as user 1 in this example, and IGD authenticates it to be genuine user with full rights and lets his request to pass through to access the web as shown in step 6. Now, after some time when a new user communicates to COHO device, COHO first identifies the user as shown in step 7. Now in step 8, a connection request is placed by COHO device as shown in step 8. In step 9, current user information is shared with IGD, which helps IGD to do authentication, verification and identify the access rights of the current user. Now when the current user places a web request to access web as shown in step 10, IGD verifies and certifies the access rights of the current user in step 11. It then ascertains that current user has limited access to web and in step 12, allows it to access web with certain restrictions as setup by IGD admin.

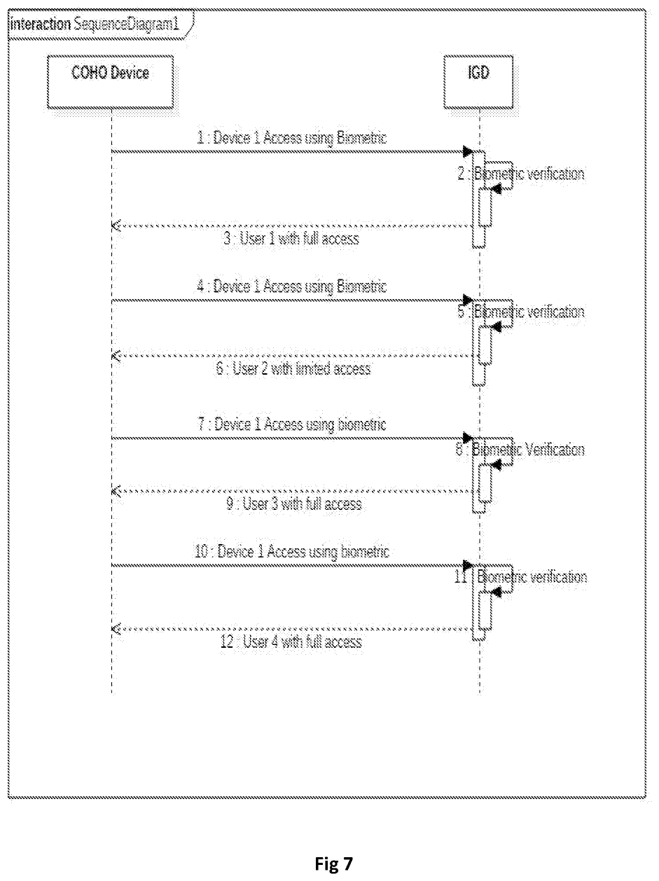

FIG. 7 is an interaction sequence diagram representing one of the embodiment where a Connected Home Device has several users, using it. In step 1, COHO device accesses the IGD device with the biometric information of the user 1, in step 2, IGD does a biometric verification of the credentials received in previous step, with the credentials saved in its own database and recognizes that user 1 has FULL access and informs the same to COHO device in step 3. COHO device again makes a connection to IGD with biometric details of the user in step 4. After verifying the user credentials received in step 4 and comparing with the credentials stored with IGD itself, as shown in step 5, the COHO device was informed in step 6 that user 2 has limited access of the internet. In step 7, COHO device accesses the IGD device with the biometric information of the user and as depicted in step 8, IGD does a biometric verification of the credentials received in step 7 with the credentials saved in its own database and recognizes that user 3 has FULL access and informs the same to COHO device in step 9. In step 10, COHO device accesses the IGD device with the biometric information of the user, in step 11, IGD does a biometric verification of the credentials received in step 10 with the credentials saved in its own database and recognizes that user 4 has FULL access and informs the same to COHO device in step 12.

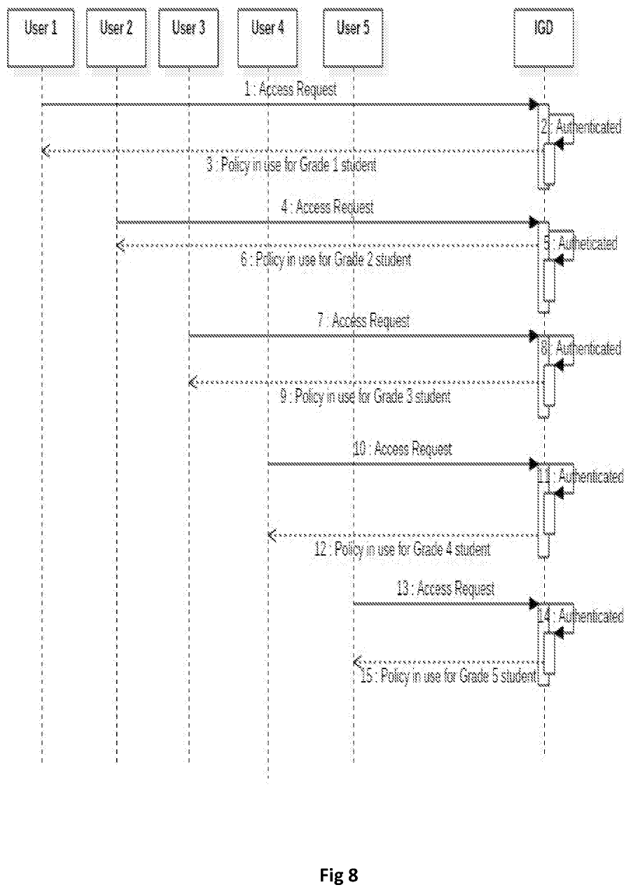

FIG. 8 depicts a very good use case of a school in the form of a sequence diagram depicting the series of events, what and how they happen. When the User 1, in step 1, tries to access the internet, IGD verifies the user using the biometric data in step 2 and finds it to be genuine. In step 3, same is informed that priorities, permissions and privileges set for a grade 1 student. In step 4 when the User 2 tries to access the internet, at step 5 he/she is authenticated using biometric data and confirmed in step 6 that policies, permissions and privileges are set for Grade 2 student. In step 7, when a User 3 tries to access the internet, in step 8 he is authenticated using the biometric information and informed back in step 9 that policies, permissions and priorities are set for Grade 3 student. In step 10, when User 4 tries to access the internet, he is authenticated by IGD at step 11 using biometric information and informed back in step 12 that policies, priorities and permissions are set for Grade 4 student. In step 13, when User 5 tries to access the internet, he is authenticated using biometric credentials in step 14 and the information regarding the policies, priorities and permissions are set which are appropriate for grade 5 student is sent to the user in step 15.

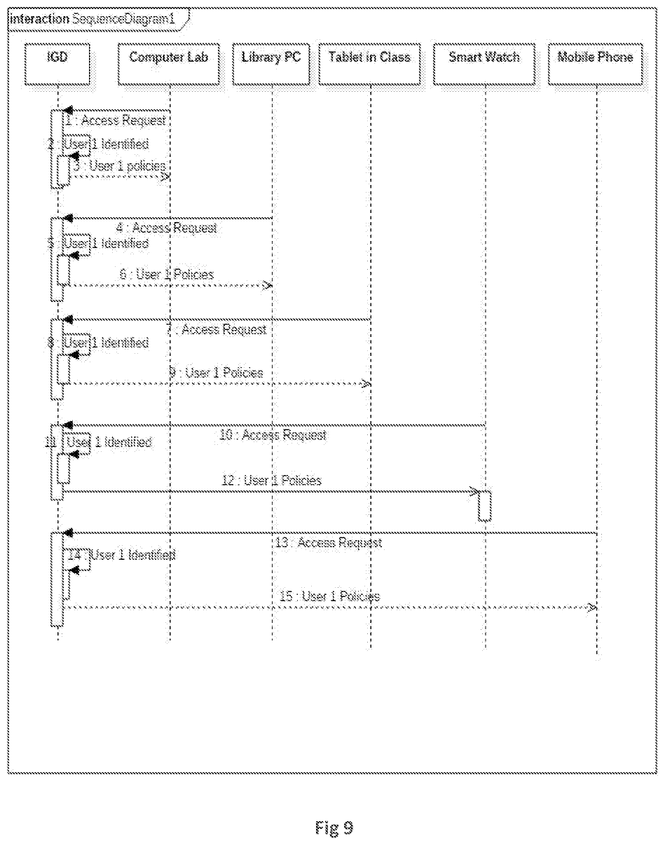

FIG. 9 is a communication diagram explaining how the concept of single user, any device, same permissions concept using centralized biometric user profile will be helpful in a place like School. In step 1, when a user, uses a computer in computer lab, he is identified in step 2 as user 1, by IGD using biometric credentials and gets the access based on the policies set for him in step 3, by admin in the IGD. In step 4, when the same user visits the school library and accesses the computer there, he is identified by IGD in step 5 as user 1 and the policies are set for him as defined for User 1 and in step 6, IGD informs the policies are set for him. In step 7, when the same user operates a Tablet in the class, he enters his biometric credentials and when he places an access request, his credentials are verified by IGD as shown in step 8. In step 9 and he gets the same access permissions that were set for him in IGD for all the devices. When the same user access internet on any of his personal gadget, here we are taking a smart watch as a reference, he gets the internet access based on the credentials that were passed on in step 10, the IGD verified the credentials in step 11 and was informed in step 12 of the same permissions that were set for him. In step 13, when the user, uses his personal gadget again, this time his phone, he places a web access request and he is identified by IGD as user 1 in step 14 and he is informed of the permissions being set as user 1 in step 15. This diagrams tries to explain how the centralized biometric profile setup in the router helps to get the same permission on all devices for any user.

The information, process and sequence of events and steps described above explain about the concept and usage of Centralized biometric user profile setup in internet gateway device and has a very good use case of implementation in

Schools, Offices, Hospitals and any public place or building where we have large number of users. Instead of maintaining the different network configurations and allowing different users with different passwords, we can have a single network which will provide a user with same privileges on any device.

It is understood that the specific order or hierarchy of steps in the process and flowcharts disclosed is an illustration of exemplary approaches. Based upon design preferences, it is understood that the specific order or hierarchy of steps in the process/flow charts may be rearranged. Further, some steps may be combined or omitted. The accompanying method claims present elements of the various steps in a sample order, and are not meant to be limited to the specific order or hierarchy presented. The methods and systems can employ Artificial Intelligence techniques such as machine learning and iterative learning. Examples of such techniques include, but are not limited to, expert systems, case based reasoning, Bayesian networks, and behavior based AI, fuzzy networks, neural networks, evolutionary computation, swarm intelligence and hybrid intelligent systems.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, where in reference to an element in the singular is not intended to mean “one and only one” unless specifically so stated, but rather “one or more”. The word “exemplary” is used herein to mean “serving as an example, instance or illustration”. Any aspect described herein as “exemplary” is not necessarily to be construed as preferred or advantageous over other aspects. Unless specifically stated otherwise, the term “some” refers to one or more. All structural and functional equivalents to the elements of the various aspects described throughout this disclosure that are known or later come to be known to those to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for creating Centralized Biometric User's Profile or plurality of Biometric User's profile in Internet Gateway Device “IGD” or Customer Premise Equipment“CPE” which can be either managed or unmanaged, comprising: Entering details of all the Network users and creating their biometric profile or plurality of biometric user profiles; Details of all the users include name, age and biometric details of users which will help to identify users.

2. The method of claim 1, wherein biometric information comprises one or more fingerprint information, voice samples, and electrocardiogram information, tissue capacitance measurements, touch-based behavioral movements (e.g., Silent Sense), face recognition, retina scan, and any other biometric information and any other form of biometric information known, but not limited to above.

3. The method of claim 1, wherein creating a biometric profile comprises:
Adding biometric information and adding restrictions or permissions or access level is done through a mobile device, a website or application developed for specific purpose and having an interface with the IGD or CPE.

4. The method of claim 1, wherein adding/capturing biometric information comprises, receiving information and data through various biometric sensors, apparatus/devices or downloading and copying them from other sources.

5. A method of claim 1, wherein creating the Centralized Biometric users Profile in IGD or CPE further comprises;
Inside the LAN or outside the LAN, i.e. WAN using the app of IGD or the web URL.

6. A method of claim 1, further comprises;
Providing an Interface of IGD that can be used to save the biometric information of the user, if the provided user's biometric information doesn't match with any of the existing biometric user profiles.

7. A method of adding restrictions or setting permission or access level to a biometric user profile or plurality of biometric user profiles created in the Internet Gateway Device, comprising;
Each Biometric User Profile will be given specific set of permissions by the IGD or CPE admin, which can be reconfigured or modified at any time.

8. A method of claim 7, further comprising;
Full access is allowed to access the internet with no restrictions.
Restricted access is allowed to visit certain websites only and has restrictions on what he can watch over the internet using the IGD.
No Access is similar to user not found with no or limited access at lowest possible speed.

9. A method of biometric identification of a user is done at IGD by software program, comprising;
Identification, based on the biometric information of each user received from the device on which user wants to access internet or web and comparing that biometric information received, with corresponding stored biometric information associated with stored user profiles or plurality of user profiles;
This biometric info can be fingerprint information, voice samples, and electrocardiogram information, tissue capacitance measurements, touch-based behavioral movements (e.g., Silent Sense), face recognition, retina scan, and any other biometric information.

10. A method of claim 9, further comprises;
IGD may request the biometric information of the current user either at;
The session setup so as to do verification and authentication with IGD for access rights of the user.
Or, at each incoming access request so as to do verification and authentication with IGD for access rights of the user.

11. A method of claim 9, further comprises:
devices which are internet enabled, like mobile phones, tablets, laptops, computers, smart home devices, Smart TV, streaming devices, etc. can either;
Identify the user and contact IGD or CPE proactively checking for user privileges before allowing a user to perform certain actions like purchase, rent and watch.
OR
IGD apparatus or the software program can query the user devices periodically to get the current user's biometric information, to access the permissions or restrictions set to the current user.

12. A method of claim 9, further comprises:
APPS which need internet access and installed on a device which facilitates the internet network access, like mobile phones, tablets, computers, smart home devices, smart TV, streaming devices, etc. can send current user's biometric profile information to IGD for user identification, verification and access rights purpose;
Apps, can proactively coordinate with IGD or CPE before allowing a user to perform certain actions For example but not limited to Banking and Credit card apps.

13. A method of claim 9, further comprises: a user with no biometric credentials match in IGD or a guest user is either denied the access or provided a limited access of web at lowest speed.

14. A method of claim 9, further comprises: a device which can't provide biometric information has to provide a unique identifier or user information to IGD to get the access level verified and permissions set in IGD. For example, but not limited to, providing User ID, Employee ID, Student ID.

15. The methods and systems for identification and authorization of a user by IGD or CPE comprising:
Artificial Intelligence techniques such as machine learning and iterative learning. Examples of such techniques include, but are not limited to, expert systems, case based reasoning, Bayesian networks, and behavior based AI, fuzzy networks, neural networks, evolutionary computation, swarm intelligence and hybrid intelligent systems.

16. A method of permission updating, comprising:
Permission modification of a user by admin, gets reflected across all the devices, irrespective if they have a mechanism of caching and storing the last retrieved permissions and values. This can be achieved by any one of the following methods, but not limited to;
Event handling—sending an event to all the devices in case there is a change in the biometric information for any user Callback mechanism—All devices who participate in Centralized biometric Profile setup can have a call back registered with the IGD or CPE, which can update the change happened. Devices can query the IGD periodically at any predetermined amount of set interval.

17. A method of claim 16, further comprises: when IGD informs the apps or device or plurality of devices and apps, about permissions associated with certain user in this network periodically and apps/device can save this info locally and take actions without contacting IGD at every request.

18. A method of claim, comprising: a mechanism if a user is not allowed to access web or some specific web sites, he/she can request the same using IGD interface and a software program which will send a request to the admin for approval. Admin can approve the same using a common platform, after identification and verification of biometric credentials of a user.

19. The method of claim, comprising: an apparatus IGD and process or program, which claims of saving and securing the biometric profile information of users who wants to access network,
Either locally on the apparatus on or on the network.
Storing information either in the form of database or in the table or any other form but not limited to above, either locally or on the network

20. A method of centralized biometric User profile setup, comprising: devices which are communicating either inside the Local Area Network (LAN) or wants to communicate outside, to the Wide Area Network (WAN/web).
